(19) United States
(12) Patent Application Publication
(10) Pub. No.: US 2011/0153320 A1
(43) Pub. Date: Jun. 23, 2011

(54) DEVICE AND METHOD FOR ACTIVE NOISE CANCELLING AND VOICE COMMUNICATION DEVICE INCLUDING THE SAME

(75) Inventors: Ik-Soon KIM, Daejeon (KR); Tae-Ho KIM, Gunpo (KR); Dong-Sun LIM, Daejeon (KR); Chae-Deok LIM, Daejeon (KR)

(73) Assignee: Electronics and Telecommunications Research Institute, Daejeon (KR)

(21) Appl. No.: 12/964,989

(22) Filed: Dec. 10, 2010

(30) Foreign Application Priority Data
Dec. 18, 2009 (KR) 10-2009-0126727
Mar. 2, 2010 (KR) 10-2010-0018478

(51) Int. Cl. G10L 21/02

(52) U.S. Cl. 704/226

(57) ABSTRACT

Provided is a device for active noise cancelling. The active noise cancelling device may include a phase inverter to generate and output a phase-inverted signal from an input voice signal, and an output unit to output the phase-inverted signal to an outside, and to thereby offset the voice signal.

### CROSS REFERENCE TO RELATED APPLICATIONS

This application claims priority to Korean Patent Application No. 10-2009-0126727 filed on Dec. 18, 2009 and Korean Patent Application No. 10-2010-0018478 filed on Mar. 2, 2010, the entire contents of which are herein incorporated by reference.

### BACKGROUND OF THE INVENTION

1. Field of the Invention

The present invention relates to a noise cancelling technology, and more particularly, to a device for active noise cancelling that may prevent a voice of a caller from dispersing to the outside, a voice communication device including the active noise cancelling device, and an operation method of the voice communication device.

2. Description of the Related Art

Currently, with the development of communication technologies, every individual may carry a portable communication terminal. Individuals using a personal portable communication device may make a voice call without restrictions on a time and a location.

However, in this communication environment, noise occurring while making a call using a personal communication terminal becomes an issue. For example, in an area where people are concentrated such as a train, a bus, and the like, or in a public location such as an office, a library, and the like, when making a call using a personal portable communication terminal, a voice of a caller may be heard by people around the caller, thereby disturbing the surrounding people or exposing a private conversation of the caller to them.

To prevent the above situation, every communication terminal manufacturing company has developed and distributed a variety of technologies, for example, a technology enabling a small voice to be audible in a normal voice to a callee even though a caller makes a voice call in the small voice, and the like.

However, the conventional technology may not completely prevent a voice of a caller and thus surrounding people adjacent to the caller may also hear the voice of the caller.

### SUMMARY OF THE INVENTION

The present invention has been made in an effort to provide a device for active noise cancelling that may remove a voice of a caller.

Further, the present invention has been made in an effort to provide a voice communication device including an active noise cancelling device.

Further, the present invention has been made in an effort to provide an operation method of a voice call device.

An exemplary embodiment of the present invention provides a device for active noise cancelling, including: a phase inverter to generate and output a phase-inverted signal from an input voice signal; and an output unit to output the phase-inverted signal to an outside, and to thereby offset the voice signal.

Another exemplary embodiment of the present invention provides a voice communication device, including: a transmitter to receive a voice signal from a user; an active noise cancelling device to receive the voice signal, to output a phase-inverted signal from the voice signal, and to thereby offset the voice signal; and a receiver to transfer the voice signal to the user.

Still another exemplary embodiment of the present invention provides an operation method of a voice communication device, including: generating a phase-inverted signal from a voice signal input from a caller; and outputting the generated phase-inverted signal to a surrounding area of the caller to thereby offset the voice signal.

According to the exemplary embodiments of the present invention, an active noise cancelling device, a voice call device including the active noise cancelling device, and an operation method of the voice call device may generate and output a phase-inverted signal of the same magnitude from a voice signal input from a caller, and thereby offset the voice signal through mixing of the voice signal and the phase-inverted signal, and may prevent a voice of the caller from dispersing through a surrounding area.

In addition, to prevent a confusion of the caller, the voice signal may be transferred only to a caller and thus the caller may make a call with a callee without inflicting undesired noise to surrounding people.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of an active noise cancelling device according to an exemplary embodiment of the present invention;

FIG. 2 is an operational flowchart of the active noise cancelling device of FIG. 1;

FIG. 3 is an operational waveform diagram of the active noise cancelling device of FIG. 1;

FIG. 4 is a schematic configuration diagram of a voice call device including the active noise cancelling device of FIG. 1 according to an exemplary embodiment of the present invention; and

FIG. 5 is an operational flowchart of the voice call device of FIG. 4.

### DETAILED DESCRIPTION OF THE PREFERRED EMBODIMENTS

The accompanying drawings illustrating exemplary embodiments of the present invention and contents described in the accompanying drawings should be referenced in order to fully appreciate operational advantages of the present invention and objects achieved by the exemplary embodiments of the present invention.

Hereinafter, the present invention will be described in detail by describing exemplary embodiments of the present invention with reference to the accompanying drawings. Like elements refer to like reference numerals shown in the drawings.

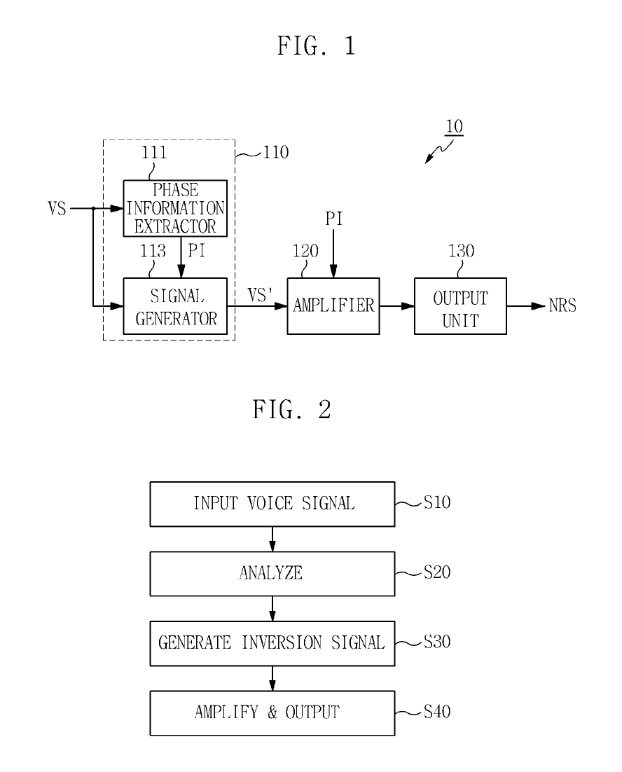

FIG. 1 is a schematic block diagram of an active noise cancelling device according to an exemplary embodiment of the present invention.

Referring to FIG. 1, the active noise cancelling device 10 may prevent call noise occurring from a user, for example, a caller, that is, a voice signal VS of the caller from being transferred to a surrounding area.

The active noise cancelling device 10 may include a phase inverter 110, an amplifier 120, and an output unit 130.

The phase inverter 110 may output an inversion signal VS′, for example, phase-inverted signal from the input voice signal VS. The inversion signal VS′ may be generated by modulating a phase of the voice signal VS.

The phase inverter 110 may include a phase information extractor 111 and a signal generator 113.

The phase information extractor 111 may extract, from the input voice signal VS, phase information PI including, for example, a cycle of the voice signal VS, an amplitude thereof, and the like.

The signal generator 113 may generate and output the inversion signal VS′ from the voice signal VS, based on the phase information PI that is output from the phase information extractor 111.

The signal generator 113 may generate and output a 180-degree phase inverted inversion signal VS′, that is, phase-inverted signal, from the voice signal VS, based on the phase information PI.

In this case, the signal generator 113 may output the phase-inverted inversion signal VS′ by half-cycle shifting the voice signal VS.

The amplifier 120 may amplify the inversion signal VS′ output from the signal generator 113, and thereby output the amplified inversion signal VS′.

The amplifier 120 may amplify the inversion signal VS′ so that the inversion signal VS′ may have substantially the same magnitude (amplitude) as the voice signal VS within the margin of error, based on the phase information PI that is output from the phase information extractor 111.

The output unit 130 may output, as a noise removed signal NRS, the inversion signal VS′ amplified by the amplifier 120 to a surrounding area of the caller. The output unit 130 may be configured as a speaker and the like.

Specifically, the output unit 130 may output, to the surrounding area of the caller, the noise removed signal NRS having the same magnitude as the voice signal VS, whereby the voice signal VS generated by the caller may be offset by the inversion signal VS′.

Accordingly, it is possible to prevent the voice signal VS of the caller from being transferred (dispersing) to people positioned around the caller.

In the meantime, when the voice signal VS of the caller is offset according to the noise removed signal NRS output from the output unit 130, the caller may barely hear the caller's own voice and thus be confused.

To prevent the above situation, the active noise cancelling device 10 may further include a device that may transmit, to a callee as is, the voice signal VS input from the caller, for example, an ear speaker attached to an ear of the caller, and the like.

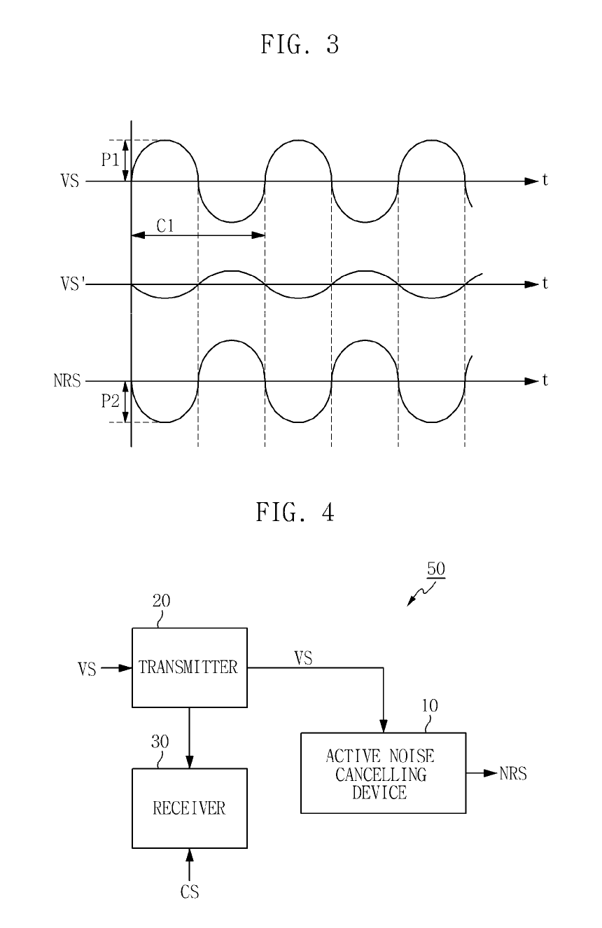

FIG. 2 is an operational flowchart of the active noise cancelling device of FIG. 1, and FIG. 3 is an operational waveform diagram of the active noise cancelling device of FIG. 1.

Referring to FIG. 1 and FIG. 2, when a caller inputs a voice via a microphone (not shown), a voice signal VS output from the microphone may be input into the phase inverter 110 of the active noise cancelling device 10 (S10).

The phase information extractor 111 of the phase inverter 110 may output phase information PI by analyzing the input voice signal VS (S20). Here, the phase information PI may include a cycle of the voice signal VS, an amplitude thereof, and the like.

The signal generator 113 of the phase inverter 110 may generate and output an inversion signal VS′ from the input voice signal VS, based on the phase information PI that is output from the phase information extractor 111 (S30).

Here, the signal generator 113 may generate the inversion signal VS′ by half-cycle shifting the voice signal VS. The inversion signal VS′ may have a phase difference of 180 degrees with respect to the voice signal VS.

The amplifier 120 of the active noise cancelling device 10 may amplify the inversion signal VS′, output from the signal generator 113, to have the same magnitude as the voice signal VS. The output unit 130 may output, as the noise removed signal NRS, the amplified inversion signal VS′ to an outside, that is, to the surrounding area of the caller (S40).

Referring to FIG. 1 and FIG. 3, the voice signal VS generated by the caller may appear as a sinusoidal signal having a first amplitude P1 and a first cycle C1 on a time axis t. The substantial voice signal VS may appear as a combination of a plurality of sinusoidal signals. However, in the exemplary embodiment, an example where the voice signal VS appears as a single sinusoidal signal will be described for concise description.

The signal generator 113 may generate and output the inversion signal VS′ of which a phase is half-cycle shifted from the voice signal VS on the time axis t, that is, from the first cycle C1 of the voice signal VS analyzed by the phase information extractor 111.

Next, the active noise cancelling device 10 may amplify the generated inversion signal VS′ and thereby output the noise removed signal NRS.

The noise removed signal NRS may correspond to a signal having a phase difference of 180 degrees with respect to the voice signal VS on the time axis t, and having the substantially same amplitude (P1=P2) as the voice signal VS.

Specifically, the active noise cancelling device 10 of the present invention may output the noise removed signal NRS of the same amplitude P2 having a phase difference of 180 degrees with respect to the voice signal VS, and thereby offset the voice signal VS generated from the caller.

FIG. 4 is a schematic configuration diagram of a voice call device including the active noise cancelling device of FIG. 1 according to an exemplary embodiment of the present invention.

The voice call device 50 according to an exemplary embodiment of the present invention may correspond to a personal portable mobile communication terminal such as a mobile phone, a smart phone, a personal digital assistant (PDA), and the like, however, is not limited thereto.

The voice call device 50 may include a transmitter 20, a receiver 30, and the active noise cancelling device 10.

The active noise cancelling device 10 may be configured to be substantially the same as described above with reference to FIG. 1 through FIG. 3, and thus further description related thereto will be omitted here.

The transmitter 20 may denote a device into which a voice of a user, that is, a caller is input. The transmitter 20 may be configured as a microphone and the like.

The receiver 30 may receive a callee sound CS from a counter party communicating with the caller, that is, a callee, and may transfer the callee sound CS to the caller.

In addition, the receiver 30 may transfer, to the caller, the voice signal VS of the caller that is output from the transmitter 20.

The transmitter 20 may output, to the active noise cancelling device 10, the voice signal VS that is input from the caller.

In response to the voice signal VS input from the transmitter 20, the active noise cancelling device 10 may generate a noise removed signal NRS and output the generated the noise removed signal NRS to the surrounding area of the caller.

The voice signal VS of the caller may be offset by the noise removed signal NRS that is output from the active noise cancelling device 10, which may prevent the voice signal VS from dispersing to a surrounding area of the caller.

Also, the transmitter 20 may transfer the voice signal VS of the caller to the receiver 30, and the receiver 30 may transfer the voice signal VS to the caller.

This is to prevent a confusion of the caller, which may occur when the voice signal VS of the caller is offset by the active noise cancelling device 10. The caller may verify contents according to the caller's voice signal VS transferred via the receiver 30.

The caller's voice signal VS may be transferred to the caller via the receiver 30 according to a predetermined rule when the caller makes a phone call with the callee, for example, a rule that when the voice signal VS is transferred from the caller to the callee, the callee sound CS is transferred from the callee to the caller.

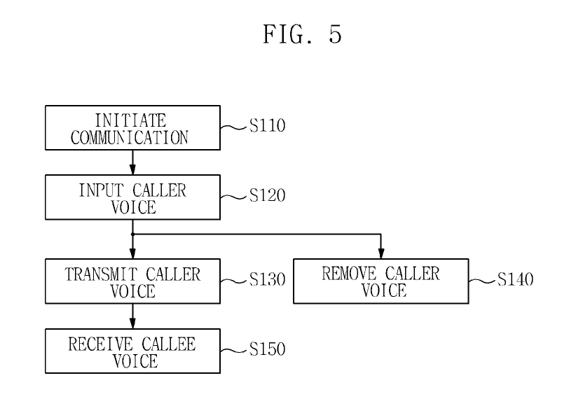

FIG. 5 is an operational flowchart of the voice call device of FIG. 4.

Referring to FIG. 4 and FIG. 5, a caller may initiate a communication by attempting to make a call with a counter party, that is, a callee using the caller's communication terminal, for example, a mobile phone (S110).

When the communication between the caller and the callee is initiated, the caller may input the caller's voice signal VS via the transmitter 20 (S120).

The caller's voice signal VS may be input into the active noise cancelling device 10 via the transmitter 20 (S140).

The active noise cancelling device 10 may generate a noise removed signal NRS from the input voice signal VS and thereby output the generated noise signal NRS to the surrounding area of the caller. The noise removed signal NRS may be mixed with the voice signal VS to thereby offset the voice signal VS.

In the meantime, the caller's voice signal VS may be transferred to the receiver 30 via the transmitter 20, and the receiver 30 may transfer the caller's voice signal VS to the caller. In addition, the transmitter 20 may transfer the caller's voice signal VS to the callee via a communication network (not shown) (S130).

The callee receiving the voice signal VS from the caller may input a callee's voice signal, that is, the callee sound CS corresponding to the caller's voice signal VS using a transmitter of the callee's communication terminal. In this case, an active noise cancelling device according to the present invention may be included in the callee's communication terminal.

The callee sound CS input from the callee may be transferred to the receiver 30 via the communication network. The receiver 30 may transfer the callee sound CS to the caller (S150).

While the present invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A device for active noise cancelling, comprising:
a phase inverter for generating a phase-inverted signal from a voice signal; and
an output unit for outputting the phase-inverted signal to an outside to offset the voice signal.

2. The device of claim 1, wherein the phase inverter includes a signal generator for generating the phase-inverted signal corresponding to a 180-degree phase inverted signal from phase information of the voice signal.

3. The device of claim 2, wherein the signal generator generates the phase-inverted signal by half-cycle shifting the voice signal based on the phase information.

4. The device of claim 2, wherein the phase inverter further includes a phase information extractor for extracting the phase information by analyzing a waveform of the voice signal.

5. The device of claim 1, further comprising:
a signal amplifier for amplifying the phase-inverted signal to have the same magnitude as the voice signal, and outputting the amplified phase-inverted signal.

6. A voice communication device, comprising:
a transmitter for inputting a voice signal from a user;
an active noise cancelling device for receiving the voice signal and outputting a phase-inverted signal from the voice signal to offset the voice signal; and
a receiver for transferring the voice signal to the user.

7. The voice communication device of claim 6, wherein the active noise cancelling device includes:
a phase inverter for generating and outputting a phase-inverted signal from an input voice signal; and
an output unit for outputting the phase-inverted signal to an outside, and offsetting the voice signal.

8. The voice communication device of claim 7, wherein the phase inverter includes a signal generator for generating and outputting the phase-inverted signal corresponding to a 180-degree phase inverted signal from phase information of the voice signal.

9. The voice communication device of claim 8, wherein the signal generator generates the phase-inverted signal by half-cycle shifting the voice signal based on the phase information.

10. The voice communication device of claim 8, wherein the phase inverter further includes a phase information extractor for extracting the phase information by analyzing a waveform of the voice signal.

11. The voice communication device of claim 6, further comprising:
a signal amplifier for amplifying the phase-inverted signal to have the same magnitude as the voice signal, and outputting the amplified phase-inverted signal.

12. A noise cancelling method of an active noise cancelling apparatus, comprising:
generating a phase-inverted signal from a voice signal input from a caller; and
outputting the generated phase-inverted signal to a surround area of the caller to offset the voice signal.

13. The method of claim 12, wherein the generating of the phase-inverted signal extracts phase information from the voice signal, and generates the phase-inverted signal based on the extracted phase information.

14. The method of claim 13, wherein the generating of the phase-inverted signal generates the phase-inverted signal by half-cycle shifting the voice signal based on the phase information.

15. The method of claim 13, wherein the generating of the phase-inverted signal generates and outputs the phase-inverted signal that is a 180-degree phase inverted signal from the voice signal based on the phase information.

16. The method of claim 12, wherein the generating of the phase-inverted signal further includes amplifying the phase-inverted signal to have the same magnitude as the voice signal, and to thereby output the amplified phase-inverted signal.

17. The method of claim 12, further comprising:
transferring the voice signal to the caller through a receiver.
